(19) United States
(12) Patent Application Publication
(10) Pub. No.: US 2025/0048976 A1
(43) Pub. Date: Feb. 13, 2025

(54) METHODS FOR REDUCING GERMINATION TIME FOR RUBUS SEEDS

(71) Applicant: Pairwise Plants Services, Inc., Durham, NC (US)

(72) Inventors: Joel Reiner, Raleigh, NC (US); Brian Charles Wilding Crawford, Cary, NC (US); Andrew Fister, Morrisville, NC (US)

(21) Appl. No.: 18/716,563

(22) PCT Filed: Oct. 20, 2022
(86) PCT No.: PCT/US2022/078401

§ 371 Date: Jun. 5, 2024

Related U.S. Application Data
(60) Provisional application No. 63/270,086, filed on Oct. 21, 2021.

(51) Int. Cl. A01G 22/05; A01G 9/02; A01G 9/14; A01G 24/00

(52) U.S. Cl. CPC A01G 22/05; A01G 9/02; A01G 9/14; A01G 24/00

(57) ABSTRACT

This disclosure relates to methods for modifying the time needed for Rubus seeds to germinate, thereby reducing the time required to produce a Rubus plant.

### FIELD OF THE INVENTION

This invention relates to methods for modifying the time needed for Rubus seeds to germinate, thereby reducing the time required to produce a Rubus plant. In addition, the invention relates to plants produced by the methods described herein.

### BACKGROUND OF THE INVENTION

Rubus seed has a long and variable germination process which can add years to both breeding programs and multi-generational genetic studies. Most Rubus spp. require a minimum warm stratification at 20-30C for 90 days followed by cold stratification at 2 to 5 C for an additional 90 days before germination can occur (Brinkman, Agriculture Handbook No. 450). Washington, DC: U.S. Department of Agriculture, Forest Service, p. 738-743 (1974); Jennings Raspberries and blackberries: their breeding, disease and growth. London, Academic Press, 233pp (1988)). This dormancy requirement means that under typical germination protocols, F1 progeny or seed generated by either crossing or selfing a Rubus plant will not be germinated until the late winter/early spring following the initial cross. This delays evaluation of plant and fruit by at least one year.

The present invention overcomes the shortcomings in the art by providing methods that reduce seed germination time in Rubus, thus reducing the time to achieve a Rubus plant.

### SUMMARY OF EXAMPLE EMBODIMENTS

One aspect of the invention provides a method of reducing germination time of Rubus (Rubus spp. and/or Rubus ideaus) seeds, the method comprising: (a) cutting each of one or more Rubus seeds into two portions to produce Rubus seed portions; and (b) cultivating the Rubus seed portions on a germination medium in a humid environment to produce one or more seedlings with a radicle, thereby reducing the time to germination of the Rubus seeds.

A further aspect of the invention provides a method of reducing time from seed to production of Rubus (Rubus spp. and/or Rubus ideaus) seedlings having roots and plumules, the method comprising: (a) cutting each of one or more Rubus seeds into two portions to produce Rubus seed portions; (b) cultivating the Rubus seed portions on a germination medium in a humid environment to produce one or more Rubus seedlings having a radicle and optionally having two cotyledons; and (c) cultivating the one or more Rubus seedlings with a radicle and optionally two cotyledons to produce one or more Rubus seedlings having roots and a plumule.

In addition, the present invention provides Rubus plants and seedlings produced by the methods described herein.

These and other aspects of the invention are set forth in more detail in the description of the invention below.

### DETAILED DESCRIPTION

The present invention now will be described hereinafter with reference to the accompanying drawings and examples, in which embodiments of the invention are shown. This description is not intended to be a detailed catalog of all the different ways in which the invention may be implemented, or all the features that may be added to the instant invention. For example, features illustrated with respect to one embodiment may be incorporated into other embodiments, and features illustrated with respect to a particular embodiment may be deleted from that embodiment. Thus, the invention contemplates that in some embodiments of the invention, any feature or combination of features set forth herein can be excluded or omitted. In addition, numerous variations and additions to the various embodiments suggested herein will be apparent to those skilled in the art in light of the instant disclosure, which do not depart from the instant invention. Hence, the following descriptions are intended to illustrate some particular embodiments of the invention, and not to exhaustively specify all permutations, combinations and variations thereof.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

All publications, patent applications, patents and other references cited herein are incorporated by reference in their entireties for the teachings relevant to the sentence and/or paragraph in which the reference is presented.

Unless the context indicates otherwise, it is specifically intended that the various features of the invention described herein can be used in any combination. Moreover, the present invention also contemplates that in some embodiments of the invention, any feature or combination of features set forth herein can be excluded or omitted. To illustrate, if the specification states that a composition comprises components A, B and C, it is specifically intended that any of A, B or C, or a combination thereof, can be omitted and disclaimed singularly or in any combination.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

The term “about,” as used herein when referring to a measurable value such as an amount or concentration and the like, is meant to encompass variations of ±10%, ±5%, ±1%, ±0.5%, or even ±0.1% of the specified value as well as the specified value. For example, “about X” where X is the measurable value, is meant to include X as well as variations of ±10%, ±5%, ±1%, ±0.5%, or even ±0.1% of X. A range provided herein for a measurable value may include any other range and/or individual value therein.

As used herein, phrases such as “between X and Y” and “between about X and Y” should be interpreted to include X and Y. As used herein, phrases such as “between about X and Y” mean “between about X and about Y” and phrases such as “from about X to Y” mean “from about X to about Y.”

Recitation of ranges of values herein are merely intended to serve as a shorthand method of referring individually to each separate value falling within the range, unless otherwise indicated herein, and each separate value is incorporated into the specification as if it were individually recited herein. For example, if the range of 10 to 15 is disclosed, then 11, 12, 13, and 14 are also disclosed.

The term “comprise,” “comprises” and “comprising” as used herein, specify the presence of the stated features, integers, steps, operations, elements, and/or components, but do not preclude the presence or addition of one or more other features, integers, steps, operations, elements, components, and/or groups thereof.

As used herein, the transitional phrase “consisting essentially of” means that the scope of a claim is to be interpreted to encompass the specified materials or steps recited in the claim and those that do not materially affect the basic and novel characteristic(s) of the claimed invention. Thus, the term “consisting essentially of” when used in a claim of this invention is not intended to be interpreted to be equivalent to “comprising.”

As used herein, the terms “increase,” “increasing,” “enhance,” “enhancing,” “improve” and “improving” (and grammatical variations thereof) describe an elevation of at least about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 300%, 400%, 500% or more as compared to a control.

As used herein, the terms “reduce,” “reduced,” “reducing,” “reduction,” “diminish,” and “decrease” (and grammatical variations thereof), describe, for example, a decrease of at least about 5%, 10%, 15%, 20%, 25%, 35%, 50%, 75%, 80%, 85%, 90%, 95%, 96%, 97%, 98%, 99%, 99.1%, 99.2%, 99.3%, 99.4%, 99.5%, 99.6%, 99.7%, 99.8%, 99.9%, or 100% as compared to a control. In some embodiments, the reduction can result in no or essentially no (i.e., an insignificant amount, e.g., less than about 10% or even 5%) detectable activity or amount. As an example, the germination time for a Rubus seed may be reduced by at least 68% to about 99% or more using the methods of the invention as compared to the time needed for a seed germination process in Rubus that requires stratification (either a cold stratification or a warm stratification followed by a cold stratification). In the absence of the methods of the present invention, the period for cold stratification for Rubus seed germination may be about 12 weeks to about 16 weeks at a temperature of about 33° C. to about 35° C. (e.g., germination in the field or in a refrigerator). Germination in a field (in nature) may further involve a warm stratification period of about 90 days prior to the cold stratification. A warm stratification may be optional for Rubus seeds if the seeds are obtained from mature fruit, but the seeds are not desiccated or dried down. For desiccated seed, a 90-day warm stratification may be replaced with scarification. Scarification can be used to weaken the seed coat and allows the seed to take up water. Methods of scarifying seeds can include, but are not limited to, an abrasive treatment, nicking the seed coat, or exposing the seeds to digestive chemicals including, but not limited to, concentrated sulfuric acid (98% H2SO4) or sodium hypochlorite (14% NaOCH).

As used herein, the terms “cultivar” and “variety” refer to a group of similar plants that by structural or genetic features and/or performance can be distinguished from other varieties or cultivars within a species.

As used herein, the terms “exotic,” “exotic line” and “exotic germplasm” refer to any plant, line or germplasm that is not elite. In general, exotic plants/germplasms are not derived from any known elite plant or germplasm, but rather are selected to introduce one or more desired genetic elements into a breeding program (e.g., to introduce novel alleles into a breeding program).

As used herein, the term “hybrid” in the context of plant breeding refers to a plant that is the offspring of genetically dissimilar parents produced by crossing plants of different lines or breeds or species, including, but not limited to, the cross between two inbred lines. In some embodiments, a Rubus hybrid can include but is not limited to, a hybrid between any of the Rubus species of Rubus allegheniensis (Allegheny blackberry), Rubus armeniacus (Himalayan blackberry), Rubus canadensis (Canadian blackberry), Rubus fruticosus agg. (European blackberry), Rubus laciniatus (cutleaf evergreen blackberry), Rubus pensilvanicus (Pennsylvania blackberry), Rubus trifidus (Japanese blackberry), or Rubus ursinus (trailing blackberry).

As used herein, the term “inbred” refers to a substantially homozygous plant or variety. The term may refer to a plant or plant variety that is substantially homozygous throughout the entire genome or that is substantially homozygous with respect to a portion of the genome that is of particular interest.

As used herein a “control plant” or “control seed” (e.g., control Rubus plant or control Rubus seed) means a plant or seed (e.g., a Rubus plant or seed) that is the same species, variety or cultivar as the Rubus plant or seed that has not been contacted with/not exposed to the methods (e.g., the conditions) of the invention.

As used herein, “contact,” “contacting,” “contacted,” and grammatical variations thereof, refer to placing the components of a desired reaction together under conditions suitable for carrying out the desired reaction. As an example, a Rubus seed may be contacted with the conditions as described herein (e.g., cutting of the seed and cultivating of the same) to alter the timing of germination of the Rubus seed.

The term “plant part,” as used herein, includes but is not limited to reproductive tissues (e.g., petals, sepals, stamens, pistils, receptacles, anthers, pollen, flowers, fruits, flower bud, ovules, seeds, embryos,); vegetative tissues (e.g., petioles, stems (e.g., primocane, floricane), roots, root hairs, root tips, pith, coleoptiles, stalks, shoots, branches, bark, apical meristem, axillary bud, cotyledon, hypocotyls, and leaves); vascular tissues (e.g., phloem and xylem); specialized cells such as epidermal cells, parenchyma cells, collenchyma cells, sclerenchyma cells, stomates, guard cells, cuticle, mesophyll cells; callus tissue; and cuttings. The term “plant part” also includes plant cells, including plant cells that are intact in plants and/or parts of plants. plant protoplasts, plant tissues, plant organs, plant cell tissue cultures, plant calli, plant clumps, and the like. As used herein, “shoot” refers to the above ground parts including the leaves and stems. As used herein, the term “tissue culture” encompasses cultures of tissue, cells, protoplasts and callus.

As used herein, “plant cell” refers to a structural and physiological unit of the plant, which typically comprise a cell wall but also includes protoplasts. A plant cell of the present invention can be in the form of an isolated single cell or can be a cultured cell or can be a part of a higher-organized unit such as, for example, a plant tissue (including callus) or a plant organ. In some embodiments, a plant cell can be an algal cell. A “protoplast” is an isolated plant cell without a cell wall or with only parts of the cell wall. Thus, in some embodiments of the invention, a cell of a Rubus plant or plant part includes, but is not limited to, a root cell, a leaf cell, a tissue culture cell, a seed cell, a flower cell, a fruit cell, a pollen cell, and the like. In some aspects of the invention, the plant part can be a plant germplasm.

“Plant cell culture” means cultures of plant units such as, for example, protoplasts, cell culture cells, cells in plant tissues, pollen, pollen tubes, ovules, embryo sacs, zygotes and embryos at various stages of development.

As used herein, a “plant organ” is a distinct and visibly structured and differentiated part of a plant such as a root, stem, leaf, flower bud, or embryo.

“Plant tissue” as used herein means a group of plant cells organized into a structural and functional unit. Any tissue of a plant in planta or in culture is included. This term includes, but is not limited to, whole plants, plant organs, plant seeds, tissue culture and any groups of plant cells organized into structural and/or functional units. The use of this term in conjunction with, or in the absence of, any specific type of plant tissue as listed above or otherwise embraced by this definition is not intended to be exclusive of any other type of plant tissue.

A “radicle” as used herein is an embryonic root of a seedling and is the first part of a seedling that emerges during germination.

A “cotyledon”, as used herein, is an embryonic leaf that is the first leaf to appear when a seedling is germinating. A germinating Rubus seedling produces two cotyledons.

A “plumule” is a part of a germinating seed embryo that develops into a shoot that produces the first true leaves of a plant.

Rubus seed useful with this invention may be from Rubus spp., Rubus ideaus (red raspberry), blackberry, or black raspberry.

In nature, Rubus seeds require a cold stratification for germination, the length of which can be about 12 weeks to about 16 weeks (about 84 days to about 112 days). In addition, under some conditions, e.g., field germination, a warm stratification step may be needed, adding about an additional 90 days to achieve germination. As a result, when starting from seed and taking into account growing seasons, evaluation of newly developed Rubus varieties can take at least two years (two growing seasons). To be able to evaluate offspring more quickly, the present invention provides methods for reducing the time needed for seed germination in Rubus spp. Specifically, the present invention provides methods for germinating Rubus seed that remove the need for an “over winter” step to break dormancy, thereby providing the advantage of going from seed to seedling in less than a month. These methods not only reduce the time needed germination but also reduce the time necessary for evaluating new Rubus cultivars and varieties.

Accordingly, a method of reducing germination time of Rubus (Rubus spp. and/or Rubus ideaus) seeds is provided, the method comprising: (a) cutting each of one or more Rubus seeds into two portions to produce Rubus seed portions; and (b) cultivating the Rubus seed portions on a germination medium in a humid environment to produce one or more seedlings with a radicle, thereby reducing the time to germination of the Rubus seeds. In some embodiments, a method is provided for reducing time from seed to production of Rubus (Rubus spp. and/or Rubus ideaus) seedlings having roots and plumules, the method comprising: (a) cutting each of one or more Rubus seeds into two portions to produce Rubus seed portions; (b) cultivating the Rubus seed portions on a germination medium in a humid environment to produce one or more Rubus seedlings having a radicle and optionally having two cotyledons; and (c) cultivating the one or more Rubus seedlings with a radicle and optionally two cotyledons to produce one or more Rubus seedlings having roots and a plumule, optionally wherein the method comprises transferring the one or more seedlings with a radicle and two cotyledons to a growing medium prior to the cultivating step of (c). In some embodiments, the one or more Rubus seedlings having roots and a plumule are cultivated further to produce one or more Rubus plants having true leaves.

In some embodiments, the cultivating of Rubus seed portions on a germination medium of (b) can be for about 24 hours to about 12 days (e.g., about 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 1151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287 or 288 hours, or any value or range therein; e.g., about 1, 2, 3, 4, 5, 6, 7, 8, 9, 10, 11, or 12 days; e.g., about 1, 2, 3, or 4 days to about 5, 6, 7, 8, 9, 10, 11, or 12 days).

In some embodiments, the cultivating of one or more Rubus seedlings with a radicle and optionally two cotyledons of (c) may be for about 48 hours to about three weeks (e.g., about 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 1151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250, 251, 252, 253, 254, 255, 256, 257, 258, 259, 260, 261, 262, 263, 264, 265, 266, 267, 268, 269, 270, 271, 272, 273, 274, 275, 276, 277, 278, 279, 280, 281, 282, 283, 284, 285, 286, 287, 288, 289, 290, 291, 292, 293, 294, 295, 296, 297, 298, 299, 300, 301, 302, 303, 304, 305, 306, 307, 308, 309, 310, 311, 312, 313, 314, 315, 316, 317, 318, 319, 320, 321, 322, 323, 324, 325, 326, 327, 328, 329, 330, 331, 332, 33, 334, 335, 336, 337, 338, 339, 340, 345, 350, 355, 360, 365, 370, 375, 380, 385, 390, 395, 400, 405, 410, 415, 420, 425, 435, 440, 445, 450, 460, 470, 480, 490, 500, 501, 502, 503, or 504 hours, or any value or range therein; e.g., about 2, 3, 4, 5, 6, 7, 8, 9, 10, 11, 12, 13, 14, 15, 16, 17, 18, 19, 20, or 21 days; e.g., about 1, 2, 3, 4, 5, 6, 7, 8, or 9 days to about 10, 11, 12, 13, 14, 15, 16, 17, 18, 19, 20, or 21 days).

In some embodiments, the methods of the present invention may reduce the time to germination of a Rubus seed to produce a seedling with a radicle to about 1 day to about 12 days (e.g., about 1, 2, 3, 4, 5, 6, 7, 8, 9, 10, 11, or 12 days, or any range or value therein) as compared to about 84 days to about 112 days (about 12 weeks to 16 weeks) (e.g., about 84, 85, 86, 87, 88, 89, 90, 91, 92, 93, 94, 95, 96, 97, 98, 99, 100, 101, 102, 103, 104, 105, 106, 107, 108, 109, 110, 111, or 112 days, or any range or value therein; about 12, 13, 14, 15, or 16 weeks, or any range or value therein) for a Rubus seed not exposed to or contacted with the methods of the present invention (and therefore still requiring cold stratification). Thus, in some embodiments, the time to germination of a Rubus seed to produce a seedling with a radicle may be reduced by about 75% to 99% (e.g., 75, 76, 77, 78, 79, 80, 81, 82, 83, 84, 85, 86, 87, 88, 89, 90, 91, 92, 93, 94, 95, 96, 97, 98, or 99%, or any range or value therein). In some embodiments, germination of a Rubus seed may require a warm stratification in addition to a cold stratification (e.g., germination in the field). A warm stratification for Rubus can be about an additional 90-day warm period that precedes the cold stratification. Thus, in some embodiments, the methods of the present invention may reduce time from germination of a Rubus seed to production of a plant having roots and a plumule by about 93% to 99.5% (e.g., 93, 93.5, 94, 94.5, 95, or 95.5%, or any range or value therein) when compared to Rubus seed that requires a warm stratification and a cold stratification.

In some embodiments, the methods of the present invention may reduce the time from seed to production of plants having roots and plumules to about 3 days to about 33 days (e.g., about 3, 4, 5, 6, 7, 8, 9, 10, 11, 12, 13, 14, 15, 16, 17, 18, 19, 20, 21, 22, 23, 24, 25, 26, 27, 28, 29, 30, 30, 31, 32, or 33 days, or any range or value therein) as compared to about 105 days to about 133 days (e.g., about 15 weeks to about 19 weeks) (e.g., about 105, 106, 107, 108, 109, 110, 111, 112, 113, 114, 115, 116, 117, 118, 119, 120, 121, 122, 123, 124, 125, 126, 127, 128, 129, 130, 131, 132, or 133 days or any range or value therein; e.g., 15, 16, 17, 18, or 19 weeks or any range or value therein) for a Rubus seed not exposed to or contacted with the methods of the present invention (and therefore still requiring cold stratification). Thus, in some embodiments, the time from germination of a Rubus seed to production of a plant having roots and a plumule may be reduced by about 68% to about 98% (e.g., 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, or 98%, or any range or value therein). In some embodiments, germination of a Rubus seed may require a warm stratification in addition to a cold stratification (e.g., germination in the field). A warm stratification for Rubus can be about an additional 90-day warm period that precedes the cold stratification. Thus, in some embodiments, the methods of the present invention may reduce time from germination of a Rubus seed to production of a plant having roots and a plumule by about 83% to 99% (e.g., 83, 84, 85, 86, 87, 88, 89, 91, 92, 93, 94, 95, 96, 97, 98 or 99%, or any range or value therein) when compared to Rubus seed that requires a warm stratification and a cold stratification.

In some embodiments, the conditions under which Rubus seed portions may be cultivated (e.g., step (b)), or the conditions under which Rubus seedlings with a radicle and optionally two cotyledons (e.g., step (c)) may be cultivated may comprise a humid environment and/or a temperature in a range from about 21° C. to about 28° C. (e.g., about 21, 22, 23, 24, 25, 26, 27, or 28° C.), optionally about 22° C. to about 26° C., optionally a temperature of about 24° C.

A “humid environment,” as used herein may comprise a relative humidity in a range from about 60% to about 100% (e.g., a relative humidity of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100%).

In some embodiments, the conditions under which Rubus seed portions may be cultivated (e.g., step (b)), or the conditions under which Rubus seedlings with a radicle and optionally two cotyledons may be cultivated (e.g., step (c)) may further comprise a day length of about 14 hours to about 18 hours (e.g., about 14, 15, 16, 17, or 18 hours), optionally about 16 hours.

Rubus seeds useful with this invention are mature seeds that are harvested from fully ripe fruit from Rubus plants. For example, a fully ripe blackberry fruit is deep black (dull black, not shiny) with a plump, full, and slightly tender feel. A blackberry fruit that is red or purple is not yet ripe. A ripe blackberry will pull free from the plant with only a slight tug. In some embodiments, the Rubus seeds useful with the invention may be desiccated. Rubus seeds go through a drying down process as they mature. Desiccation does not occur until the fruit is beyond ripe and is starting to disintegrate. In some embodiments, Rubus seeds for germinating as described herein are not harvested from rotten or fermenting fruit.

In some embodiments, prior to cutting, the one or more seeds may be surface sterilized. Sterilization of the seeds can comprise contacting the Rubus seeds with a disinfecting solution. In some embodiments, a disinfecting solution can include but is not limited to, a bleach (e.g., sodium hypochlorite) solution or a hydrogen peroxide solution. A bleach solution useful with the invention may be about 5% to about 30% bleach (e.g., about 5, 6, 7, 8, 9, 10, 11, 12, 13, 14, 15, 16, 17, 18, 19, 20, 21, 22, 23, 24, 25, 26, 27, 28, 29, or 30% bleach), optionally the bleach solution may be about 20% bleach (e.g., about 20% bleach and 80% water. A hydrogen peroxide solution useful for seed sterilization may comprise about 0.5% to about 5% (e.g., about 0.5, 1, 1.5, 2, 2.5, 3, 3.5, 4, 4.5, or 5% hydrogen peroxide), optionally about 3% hydrogen peroxide. When sterilizing with a bleach solution, the Rubus seeds may be maintained in the bleach solution for about 5 minutes to about 30 minutes (e.g., about 5, 6, 7, 8, 9, 10, 11, 12, 13, 14, 15, 16, 17, 18, 19, 20, 21, 22, 23, 24, 25, 26, 27, 28, 29, or 30 minutes). When sterilizing with a hydrogen peroxide solution, the Rubus seeds may be maintained in the hydrogen peroxide for about 1 minute to about 10 minutes (e.g., about 1, 2, 3, 4, 5, 6, 7, 8, 9, or 10 minutes). In some embodiments, the Rubus seeds are rinsed about 1, 2, 3, 4, or 5 times, optionally about 3 times, in water following the sterilization step and prior to cutting. In some embodiments, a sterilizing solution may further comprise a surfactant, including, but not limited to, Triton X-100.

Any appropriate seed germination medium may be used for germinating of Rubus seeds as described herein. In some embodiments, the germination medium may be sterile. In some embodiments, the germination medium may be non-sterile. In some embodiments, a germination medium may be a culture medium. A culture medium that may be useful with this invention can include, but is not limited to, Murashige and Skoog (MS) medium, B5 medium (Gamborg B5 medium), Linsmaier and Skoog Medium (LS medium), and/or White's medium. In some embodiments, a germination medium may be a potting mix. A potting mix useful with this invention may be, for example, soilless. In some embodiments, a germination medium useful with this invention may be a soilless potting mix.

In some embodiments, seedlings having a radicle and two cotyledons may be transferred from germination medium to growing medium prior to cultivating to produce one or more seedlings having roots and a plumule. A growing medium may also be used for cultivating or growing one or more Rubus seedlings having roots and a plumule to produce one or more Rubus plants having true leaves. A growing medium useful with this invention may be a potting mix. In some embodiments, a potting mix may be soilless, e.g., a soilless potting mix.

A potting mix may comprise one or more of the following components: perlite, pumice, vermiculite, zeolite, compost, peat moss, coco coir, soil basic (sand, silt, and clay), garden soil, wood bark, water, sawdust, and/or limestone. A soilless potting mix may comprise one or more of the following components: perlite, pumice, vermiculite, zeolite, compost, peat moss, coco coir, wood bark, sawdust, and/or limestone. In some embodiments, a potting mix, including a soilless potting mix, may further include fertilizer.

In some embodiments, a germination medium and/or a growing medium may include, but is not limited to, Berger mix 2, which is a general purpose plug mix for seed germination and seedling production and includes peat moss, perlite and vermiculite. In some embodiments, a growing medium may include, but is not limited to, Jiffy peat pellets or plugs, e.g., Jiffy #730.

The methods of the invention may further comprise hardening off of the one or more Rubus seedlings or the plants having roots and a plumule prior to planting in a greenhouse or a field. ““Hardening” or “hardening off” is a process in which a plant or seedling is transitioned to the more harsh and often more varied conditions (e.g., more varied and often more extreme in temperature, humidity, and light conditions) of a greenhouse or the outdoors. In some embodiments, hardening or hardening off comprises exposing the one or more Rubus seedlings or plants to conditions of at least decreasing humidity. In some embodiments, conditions of decreasing humidity (hardening off) may be carried out for about 7 days to about 5 weeks (e.g., about 7, 8, 9, 10, 11, 12, 13, 14, 15, 16, 17, 18, 19, 20, 21, 22, 23, 24, 25, 26, 27, 28, 29, 30, 31, 32, 33, 34 or 35 days, e.g., about 1 or 2 weeks to about 3, 4, or 5 weeks) to achieve a relative humidity of about 80% or lower (e.g., about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80%) to produce a hardened plant. The target relative humidity for a hardened plant varies and may be determined by the conditions in which the plant is intended to be grown (e.g., a greenhouse versus a field, and the like).

In some embodiments, a hardened plant or seedling produced by the methods of this invention may be transferred to a growing area (e.g., a field (e.g., a cultivated field, an agricultural field), a growth chamber, a greenhouse) for further growth and maturation.

In some embodiments, the methods of the invention do not comprise stratification.

In some embodiments, the methods of the invention do not comprise sterile growing environment. For example, while a sterilized media (germination and growing media) may be used for germination and growth, the growing environment may be non-sterile. In some embodiments, the media (germination and growing media) and the growing environment may be non-sterile.

The present invention further provides seedlings produced by the methods of the invention and plants produced therefrom.

The invention will now be described with reference to the following examples. It should be appreciated that these examples are not intended to limit the scope of the claims to the invention but rather are intended to be exemplary of certain embodiments. Any variations in the exemplified methods that occur to the skilled artisan are intended to fall within the scope of the invention.

### EXAMPLES

### Example 1. Rapid Germination of Mature Seeds in Soilless Mix

Mature fruits of a blackberry plant were harvested and the seeds removed by crushing the whole fruit, straining, and washing away as much of the flesh as possible using water. The freshly harvested seeds were surface sterilized by soaking in a 20% bleach in water solution for about 20 minutes followed by at least three rinses in fresh water. The surface sterilized seeds were cut approximately in half using a razor blade and the half seeds were planted on moist Berger mix 2 in a planting tray. The tray was placed inside of a PlantCon humidity chamber and maintained in low to medium light conditions (e.g., not direct sunlight light) at a temperature of 24° C.

The tray was monitored for germinating seedlings and at day 5, all of the seedlings which had germinated were transplanted to individual peat plugs/pellets (e.g., Jiffy peat pellets). The seedlings in plugs/pellets were maintained in a humid environment at a temperature of 24° C. and under standard lighting conditions and acclimated over a two-week period to greenhouse conditions of lower humidity. The acclimated seedlings were transplanted to a standard soil mix and grown under standard greenhouse conditions (e.g., about 16-hour to 18-hour days and high light (e.g., mimics sunlight).

### Example 2. Rapid Germination of Mature Seeds in MS Agar Plates

Mature fruits of a blackberry plant were harvested, and the seeds removed by crushing the whole fruit, straining, and washing away as much of the flesh as possible using water. The freshly harvested seeds were surface sterilized by soaking in a 20% bleach in water solution for about 20 minutes followed by at least three rinses in fresh water. The surface sterilized seeds were cut approximately in half using a razor blade and the half seeds were cultured on half strength Murashige and Skoog culture media supplemented with 3% sucrose and 3% agar and maintained under sterile conditions. The plates were grown under low lighting (e.g., fluorescent grow lights approximately 12 inches above the plates) for 16 hrs a day and at 24° C.

The plates were monitored for germinating seedlings and at 7 days, 28 seedlings had germinated and were transplanted to individual peat plugs.

### Example3. Rapid Germination of Mature Seed in Soilless Mix with Algae Control

Mature fruits of a blackberry plant are harvested and the seeds removed by crushing the whole fruit, straining, and washing away as much of the flesh as possible using water. The freshly harvested seeds are surface sterilized by soaking in a 20% bleach in water solution for about 20 minutes followed by at least three rinses in fresh water. The surface sterilized seeds are cut approximately in half using a razor blade and the half seeds were planted on moist Berger mix 2 in a planting tray. The Berger mix 2 is sterilized by autoclaving prior to use.

The tray with the half seeds on the sterile Berger mix 2 is placed inside of a PlantCon humidity chamber and maintained in low light conditions at a temperature of 24° C. Each day. the surface of the Berger mix 2 is misted with a 0.5% hydrogen peroxide mist to control the growth of algae. The tray is monitored for germinated seedlings and at 5 to 10 days, all of the seedlings which have germinated are transplanted to individual peat plugs.

### Example 4. High-Throughput Method of Rapid Germination of Red Raspberry

This example shows a process for generating hundreds of seedlings from a large or unlimited supply of red raspberry seed. Approximately 15 oz of fresh berries were placed into a Cuisinart SmartPower compact blending system (CPB-300) 32-oz blender jar (CPB-300JAR fitted with a cutting-assembly blade (CPB-300CA). The blender jar was then filled to the max line with de-ionized water and pulsed at “High-Pulse” for 3 seconds at a time until most of the berries were disrupted. The entire contents of the blender jar were poured into a 4 L bucket and the process repeated with a second batch of 15 oz of berries for a total of 30 oz of berries processed and placed into the bucket.

The mixture in the bucket was diluted by adding 1-2 L of de-ionized water and strained with a deep, medium-sized (15-20 cm) sieve. The contents of the sieve were rinsed with de-ionized water and then returned to the empty bucket. The bucket was rinsed with de-ionized water and the seeds allowed to settle at the bottom of the bucket. Most of the remaining pulp floated to the top of the bucket and was removed. The seeds were strained out of the mixture and rinsed with de-ionized water and transferred to a wide-mouth glass jar (500 mL) containing a freshly prepared 2% pectinase solution (1 g of pectinase (CAS 9032-75-1) dissolved in 500 mL water). The jar was incubated at room temperature and mixed overnight by placing on a rotary shaker set to 100 RPM.

The seeds were strained and rinsed with de-ionized water and transferred to a clean wide-mouth jar containing 200 mL of 70% ethanol to begin a sterilization process. After one minute incubation in the 70% ethanol, the seeds were strained and rinsed in sterile water and then incubated in a 20% (v/v) household bleach solution with 0).1ml/L Tween 20 for 20 minutes with frequent agitation. The seeds were rinsed in sterile water and transferred to a 16 oz blender cup fitted with a chopping blade (Cuisinart SmartPower compact blending system (CPB-300), chopping-assembly blade (CPB-300CHA)) along with 300 mL of sterile water to fill the blender cup to capacity. The seed/water mixture was pulsed on high for 4-5 seconds at time with several pauses to assess the seeds particle size. Pulsing was continued until about ⅔ of the seeds appeared cut/pulverized and the pulverized seeds were collected by straining through a sieve. The cut seeds were sterilized by dipping the sieve and cut seeds into a bowl with 70% ethanol and allowing them to soak for 30-40 seconds, stirring continuously before rinsing in sterile water

Cut seeds were germinated by evenly plating onto standard MS Salts media in a deep well plate using sterile techniques. The plates were sealed with micropore tape, placed into a dark growth chamber at 25° C. and monitored for germination and emergence of cotyledons, which occurred within 24-48 hours of plating. This is a high-throughput and large volume method of generating many seedlings and generally, germination rates of 20-40% were observed. One factor that likely contributed to the reduced germination rate was the non-specific way the blender cuts the seed. The blender step of cutting the seed will generate a population of seeds that range from uncut to cut multiple times. The intention of the pulsing during the blender cutting step was to generate a population of seeds that have the highest frequency of seeds that have been cut once and thus generate two portions of that seed. It is expected that those seeds which are uncut will fail to show the reduced time to germination associated with the methods described herein, or those seeds which are cut more than twice are not expected to germinate. Thus, a lower rate of germination was expected for this method that uses the blender when compared to a method where the seed was cut by hand. However, the overall number of seedlings produced in a shorter period of time using this method is increased due to the reduced time to germination of the seeds that are cut as claimed herein, thereby providing an overall greater number of seedlings. This method is useful in situations where there is little limit on the amount of input seed available and the goal is to generate a large number of seedlings.

### Example 5. Rapid Germination of Black Raspberry

Typically growing black raspberry from seed requires a first step of approximately 45 days of cold stratification before planting in a germination mix and growing in a light environment for an additional 14 days to result in seed germination. Without stratification, the germination rate for black raspberry seeds (Rubus spp generally) is below 3%. The method described in Example 1, which eliminates the stratification requirement, was used for rapid germination of Rubus occidentalis (black raspberry). Seeds were collected from mature fruit and were cut and placed in media as described in Example 1. Eight days after cutting, seeds were scored as having germinated if there was visible extension of the shoot. All test seed sets exhibited >90% germination at the time of scoring, and across experiments, 97% of seeds were successfully germinated as further described below in Table 1.

TABLE 1
Black raspberry rapid germination

| | Number of Seeds | Number of Seeds | |
|---|---|---|---|
| Experiment | Tested | Germinated | Germination Rate |
| Set 1 | 29 | 29 | 100% |
| Set 2 | 30 | 29 | 96.6% |
| Set 3 | 29 | 27 | 93.1% |
| Set 4 | 29 | 29 | 100% |
| Total | 117 | 114 | 97.4% |

The foregoing is illustrative of the present invention and is not to be construed as limiting thereof. The invention is defined by the following claims, with equivalents of the claims to be included therein.

1. A method of reducing germination time of Rubus seeds, the method comprising:
(a) cutting each of one or more Rubus seeds into two portions to produce Rubus seed portions; and
(b) cultivating the Rubus seed portions on a germination medium in a humid environment to produce one or more seedlings with a radicle, thereby reducing the time to germination of the Rubus seeds.

2. A method of reducing time from seed to production of Rubus seedlings having roots and plumules, the method comprising:
(a) cutting each of one or more Rubus seeds into two portions to produce Rubus seed portions;
(b) cultivating the Rubus seed portions on a germination medium in a humid environment to produce one or more Rubus seedlings having a radicle and optionally having two cotyledons; and
(c) cultivating the one or more Rubus seedlings with a radicle and optionally two cotyledons to produce one or more Rubus seedlings having roots and a plumule.

3. (canceled)

4. The method of claim 1, wherein cultivating of (b) is for about 24 hours to about 12 days.

5. The method of claim 2, wherein the cultivating of (c) is for about 48 hours to about three weeks.

6. The method of claim 1, wherein the germination time is reduced to about 24 hours to about 12 days as compared to about 12 weeks to about 16 weeks for a control.

7. (canceled)

8. The method of claim 2, wherein the time from seed to production of plants having roots and a plumule is reduced by about 3 days to about 35 days as compared to about 105 days to about 133 days for a control.

9.-10. (canceled)

11. The method of claim 1, wherein the cultivating of (b) comprises a temperature in a range from about 21° C. to about 28° C.

12. The method of claim 1, wherein the cultivating of (b) comprises a day length of about 14 hours to about 18 hours.

13.-18. (canceled)

19. The method of claim 1, wherein the Rubus seeds are mature seeds harvested from fully ripe fruit from Rubus plants.

20. The method of claim 1, wherein the Rubus seeds that are harvested are desiccated.

21. The method of claim 1, further comprising surface sterilizing the one or more seeds prior to cutting.

22. The method of claim 21, wherein the sterilizing comprising contacting the Rubus seeds with a disinfecting solution.

23. The method of claim 22, wherein the disinfecting solution is a bleach solution or a hydrogen peroxide solution.

24. (canceled)

25. The method of claim 23, wherein the Rubus seeds are maintained in the bleach solution for about 5 minutes to about 30 minutes.

26. (canceled)

27. The method of claim 1, further comprising exposing the one or more Rubus seedlings to conditions of decreasing humidity, thereby producing one or more Rubus seedlings or plants having roots and a plumule that are hardened.

28. The method of claim 27, wherein the conditions of decreasing humidity are carried out for about 7 days to about 5 weeks to achieve a relative humidity of about 80% or lower to produce a hardened plant.

29. (canceled)

30. The method of claim 1, wherein the method does not comprise stratification.

31. The method of claim 1, wherein the method does not comprise sterile tissue culture.

32. A seedling produced by the method of claim 1.

33. A plant produced from the seedling of claim 32.
